(19) United States
(12) Patent Application Publication
(10) Pub. No.: US 2008/0228649 A1
(43) Pub. Date: Sep. 18, 2008

(54) Method and apparatus for obtaining a protected application protected against unauthorized use by implementing a predetermined licensing model

(75) Inventor: Michael Zunke, Kirchheim (DE)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: ALADDIN EUROPE GMBH, Germering (DE)

(21) Appl. No.: 11/685,231

(22) Filed: Mar. 13, 2007

(51) Int. Cl. G06Q 30/00

(52) U.S. Cl. 705/59

(57) ABSTRACT

There is provided a method for obtaining a protected application protected against unauthorized use by implementing a predetermined licensing model, said method comprising the steps of: adding a software product to said application, said software product providing the possibility of defining one of several different manners of realizing a functionality to be used for implementing the predetermined licensing model, and defining one of the several manners of realizing the functionality and an apparatus for obtaining a protected application protected against unauthorized use by implementing a predetermined licensing model, which apparatus adds a software product to said application, said software product providing the possibility of defining one of several different manners of realizing a functionality to be used for implementing the predetermined licensing model, and defines one of the several manners of realizing the functionality. Further, there is provided a software product, which is to be added to an application in order to obtain a protected application protected against unauthorized use by implementing a predetermined licensing model, said software product providing the possibility of defining one of several different manners of realizing a functionality to be used for implementing the predetermined licensing model and a method of distributing a software application, said method comprising the steps of: protecting the software application to be distributed by adding a software product to said software application, said software product providing the possibility of defining one of several different manners of realizing a functionality to be used for implementing a predetermined licensing model, and defining one of the several manners of realizing the functionality, sending the protected software application to the user.

### FIELD OF THE INVENTION

The present invention relates to the field of protecting a software application against unauthorized use.

### BACKGROUND OF THE INVENTION

Despite the fact that most computer users today are aware that unauthorized use, copying and distribution of a software application is illegal, many show a general disregard for the importance of treating a software application as valuable intellectual property. One solution for stopping such illegal use, copying and distribution of a software application is to amend the software application before distribution such that the software application can only be executed when a secure hardware device is connected to the execution platform on which the software application is to be executed. With such a secure hardware device different hardware-based licensing models can be realized, allowing to achieve a very high protection level. The licensing model can be for example a pay-per-use license (the user has to pay a specific price for each use of the protected application) or a perpetual license (once purchased the user has the right to use the protected application for an indefinite time).

As mentioned above a predetermined licensing model can be implemented such that the execution of the protected application according to the predetermined licensing model is only possible when the secure hardware device is connected to the execution platform. Since in this case the software publisher or vendor also has to deliver the secure hardware device to the end user, this kind of protection is preferred for expensive applications. In less expensive applications, it is often preferred to implement the predetermined licensing model by locking the application to the execution platform. This can be realized by installing the application on the execution platform and by carrying out a required activation including contacting the software publisher or vendor who will issue a special licensing key adapted to the specific execution platform.

However, the steps to be carried out by the software publisher or vendor to obtain the protected application are completely different for the protection using the secure hardware device (dongle), on the one hand, and the protection using the execution platform itself, on the other hand, although the same licensing model is implemented.

Therefore, it is an object of the present invention to provide an improved method and device for obtaining a protected application protected against unauthorized use by implementing a predetermined licensing model.

Other objects and advantages of the invention will become apparent as the description proceeds.

### SUMMARY OF THE INVENTION

In one aspect, the present invention is directed to a method for obtaining a protected application protected against unauthorized use by implementing a predetermined licensing model, the method comprising the steps of: adding a software product to the application to be protected, said software product provides the possibility of defining one of several different manners of realizing a functionality to be used for implementing the predetermined licensing model, and defining one of the several manners of realizing the functionality.

With this method it is possible to split up the entire method for obtaining the protected application into a pre-protection part and a selection part. In the pre-protection part the software product is added to the application so that a pre-protected application as such is obtained. In the following selection part the manner of realizing the functionality is defined so that the vendor or software publisher does not have to decide on the specific kind of implementation of the predetermined licensing model until the selection part is carried out. In the selection part by defining the realization of the functionality it can be decided to which device (e.g. a secure hardware device or the execution platform) the protected application is locked, for example. Therefore, the vendor or software publisher can always carry out the same steps for pre-protecting the application (namely the pre-protection part). Thereafter, the vendor or software publisher is free to choose the specific kind of implementation of the predetermined licensing model in the selection part.

Examples of the predetermined licensing model are rental licensing (time based licensing that allows the user to use the license until the license expires), feature-based licensing (the ability to turn on or off features of the protected application based on the level purchased by the user), perpetual licensing (once purchased the user has the right to use the protected application for an indefinite time), pay-per-use licensing (the user must pay a specific price for each use of the protected application), and try-before-buy licensing (the user can use the protected application for a limited time before having to purchase the license).

In the inventive method it is possible that different licensing models are provided by the software product such that for each licensing model the software product provides the possibility of defining one of several different manners of realizing a functionality to be used for implementing the respective licensing model. In this case the method comprises the step of selecting one of the licensing models as the predetermined licensing model. The selection of the licensing model can be carried out before or after adding the software product to the application, however, is preferably carried out before the step of defining one of the several manners of realizing the functionality.

As a result of splitting up the method into the pre-protection part and the selection part it is possible to use the same pre-protected application to obtain protected applications having different protection levels for the same predetermined licensing model. The protection levels can be defined depending on the market in which the protected application is to be distributed. If, for example, the market is considered as being very dangerous with respect to hackers hacking the protected application, a high protection level can be defined. If, however, the market is considered as having only low hacking activities, the defined protection level can be lower. A high protection level can be achieved by locking the protected application to a secure hardware device which must be connected to an execution platform on which the protected application is executed. A lower protection value can be achieved by realizing a software based protection.

Further, the software publisher of vendor can, for example, distribute the application to be protected in an electronic manner to the end user (e.g. via the internet). The distributed software application can comprise no protection. If the end user wants to have further functions for the application the vendor or software publisher can send the end user a corresponding update which is protected according to the above described method for obtaining a protected application.

It is possible to carry out the steps for obtaining a protected application which can be electronically delivered (e.g. via the internet). The licensing functionality can be defined such that the end user is allowed to use the protected application for a limited time period only. After the expiration of the time period the execution is only allowed when a secure hardware device is connected to the execution platform on which the execution is executed, for example. The software vendor or publisher will send the necessary secure hardware device via mail so that the end user will receive the secure hardware device within the time period in which the execution of the application without the secure hardware device is possible. Therefore, a fast delivering of the software application to the end-user is possible (via the internet) and a very high protection level is achieved (via the secure hardware device needed after the expiration of the time period).

In the defining step it is also possible to define a manner of realization in which the protected application can only be used when a secure hardware device is present which is already in possession of the end user. This can be for example a SD card (secure digital card). In this case a high protection level can be achieved and the costs for the vendor or software publisher can be reduced since the vendor or software publisher does not have to provide the secure hardware device needed. Further, the protected application can be used in a more flexible manner since the license functionality is locked to the SD card which can be moved from one execution platform to another execution platform. In this case it is possible to use the protected application on the execution platform comprising the SD card to which the protected application is locked.

The software product used can be from a first company selling hardware based software protection systems. It is possible to define the manner of implementing the predetermined licensing model such that the protected application is locked to a secure hardware device of a second company selling hardware based software protection systems. This leads to the advantages that the vendor or software publisher of the application to be protected can change to the first company selling hardware based software protection systems without having to exchange all secure hardware devices of the second company at his clients in order to protect for example an update of the protected application at his client. The change to the software product of the first company can be made gradually, since it is possible to use the inventive method only for new applications or new updates and it is not necessary to protect the old applications already in possession of the clients according to the inventive method. This is possible since the clients of the vendor or software publisher can use the secure hardware device of the second company for the old applications as well as for the protected applications or updates which are obtained according to the inventive method. The clients only need to have one secure hardware device, in this case the secure hardware device of the second company.

Thus, the software publisher or vendor can use the software product from the first company and can lock the protected application to the secure hardware device of the second company. As a result, the first company can easily convince the software publisher or vendor to use their products (in particular the software product for protecting the application) since the software publisher or vendor can still use the secure hardware devices of the second company.

In the method it is possible to carry out the defining step after the adding step, in particular, the defining step can be carried out independently of the adding step. It is also possible that the defining step is already carried out in the software product in that one of the several manners of realizing the functionality is defined as default manner. Therefore, if nothing is defined after carrying out the adding step the default manner is the defined manner for realizing the functionality.

The functionality is at least one of the group comprising: The possibility of using a secure memory, using an unique identifier, a cryptographic method for decrypting data, a cryptographic method for encrypting data, secure execution of code for the protected application, a cryptographic authentication (of, for example, a secure hardware device or any other device or function used for implementing the predetermined licensing model) and a license manager.

In the defining step at least one of executable code and data for realizing the defined manner is added to the application to be protected.

In the method according to the invention a pre-protected application is obtained by adding the software product to the application, wherein the pre-protected application is copied at least twice and in each copy of the pre-protected application a different manner of realizing the functionality is defined. In particular, the manner of realizing the functionality can be defined in each copy independently from any other copy of the pre-protected application.

The manner of realizing the functionality can be defined such that the functionality is realized in a secure hardware device to be connected to an execution platform on which the protected application is executed. A secure hardware device is in particular a hardware device which is protected against hacking.

The defining step can be carried out such that the defined manner is realized or performed when installing or executing the protected application. It is also possible that the manner of realizing the functionality is defined such that the functionality is realized in an execution platform on which the protected application is executed.

In the method the software product can comprise a basic module and a router module, the router module is used for logically connecting the realized functionality to the basic module. Further, the software product can comprise a module for the functionality to be realized. However, it is also possible, that the module for realizing the functionality is added in the defining step. Of course, it is also possible, that only a part of the module for realizing the functionality is already included in the software product and that the remaining part is added during the defining step.

Further, an extension step can be carried out after adding the software product to the application, in which extension step at least one additional manner of realizing the functionality is added to the software product. This extension step provides the possibility to add additional manners of realizing the functionality to already protected applications so that it is possible to add a new manner of realizing the functionality to protected applications which are already in the user's possession. In other words, the protected applications in the field can be amended such that at least one additional manner of realizing the functionality is provided. With this step it is possible to include, for example, a new secure hardware device for protecting an already distributed protected application.

The extension step can be carried out such that at least one of the (original) different manners of realizing the functionality is replaced by the additional manner or manners added to the software product.

In another aspect, the present invention is directed to an apparatus for obtaining a protected application protected against unauthorized use by implementing a predetermined licensing model, which apparatus adds a software product to the application, the software product providing the possibility of defining one of several different manners of realizing a functionality to be used for implementing the predetermined licensing model, and defines one of the several manners of realizing the functionality. The apparatus can be, for example, a common personal computer. However, it is also possible, that the apparatus is comprised of several computers and that the adding step and the defining step are carried out on different computers of the apparatus.

The apparatus can define the manner of realizing the functionality after the step of adding the software product to the application.

Further, it is possible that the defining step is carried out in the software product in a way that one of the several manners of realizing the functionality is defined as default manner.

The functionality is at least one of the group comprising. The possibility of using a secure memory, a unique identifier, a cryptographic method for decrypting data, a cryptographic method for encrypting data, secure execution of code for the protected application, a cryptographic authentication (of, for example, a secure hardware device or any other device or function used for implementing the predetermined licensing model) and a license manager.

The apparatus can add at least one of executable code and data for realizing the defined manner to the application to be protected in the defining step.

Further, the apparatus can obtain a pre-protected application by adding the software product to the application, the pre-protected application is copied at least twice and in each copy of the pre-protected application the manner (preferably a different manner) of realizing the functionality can be defined independently from each other.

The apparatus can define the manner of realizing the functionality such that the functionality is realized in a secure hardware device to be connected to an execution platform on which the protected application is executed.

Further, the apparatus can carry out the defining step such that the defined manner is realized when installing or executing the protected application.

The apparatus can further define the manner of realizing the functionality such that the functionality is realized in an execution platform on which the protected application is executed.

The software product can comprise a basic module and a router module, the router module is used for logically connecting the realized functionality to the basic module.

In a further aspect, the invention is directed to a software product, which is to be added to an application in order to obtain a protected application protected against unauthorized use by implementing a predetermined licensing model, wherein the software product provides the possibility of defining one of several different manners of realizing a functionality to be used for implementing the predetermined licensing model.

The software product can be designed such that the manner of realizing the functionality can be defined after adding the software product to the application. Further, the software product can include the selection of one of the several different manners of realizing the functionality as the default value. Thus, the default manner is realized if only the software product is added to the application to be protected and the defining step for realizing the functionality for implementing the predetermined licensing model is already carried out by the set default value.

The functionality is at least one of the group comprising the possibility of using a secure memory, the possibility of using a unique identifier, a cryptographic method for decrypting data, a cryptographic method for encrypting data, secure execution of code of the protected application, and a license manager.

The software product can be designed such that, when defining the manner of realizing the functionality, at least one of executable code and data for realizing the defined manner is added to the application to be protected.

Further, the software product can be designed such that by adding the software product to the application a pre-protected application is obtained and wherein the pre-protected application can be copied at least twice and in each copy of the pre-protected application (preferably a different manner), the manner of realizing the functionality can be defined independently from each other.

In the software product the manner of realizing the functionality can be defined such that the functionality is realized in a secure hardware device to be connected to an execution platform on which the protected application is executed.

Further, in the software product the manner of realizing the functionality can be defined such that the defined manner is realized when installing or executing the protected application.

The manner of realizing the functionality can be defined in the software product such that the functionality is realized in an execution platform on which the protected application is executed.

The software product can comprise a basic module and a router module, said router module is used for logically connecting the realized functionality to the basic module.

In another aspect, the present invention is directed to a method of distributing a software application, said method comprising the steps of

protecting the software application to be distributed by adding a software product to the software application, the software product providing the possibility of defining one of several different manners of realizing a functionality to be used for implementing a predetermined licensing model, and defining one of the several manners of realizing the functionality,

sending the protected software application to the user.

The protected application can be electronically sent to the user, wherein the predetermined licensing model allows the use of the protected application on an execution platform for a limited time period and after expiration of the time period the execution is only allowed when a secure hardware device is connected to the execution platform, which secure hardware device is sent to the user within the limited time period.

Further, it is possible that the predetermined licensing model only allows the execution of the protected software product on an execution platform when a secure hardware device is connected to the execution platform.

The software product can be a product from a first company offering software protection systems and the secure hardware device can be from a second company offering software protection systems.

In the distributing method a pre-protected software application can be obtained by adding the software product to the software application and the pre-protected application can be copied at least twice and in each copy of the pre-protected software application a different manner of realizing the functionality can be defined.

Further, it is possible that in the distributing method the step of defining one of the several manners of realizing the functionality is carried out depending on the hacking activities expected in the market to which the user of the protected software application belongs.

It is understood that the features mentioned above and those yet to be explained below can be used not only in the respective combinations indicated, but also in other combinations or in isolation, without departing from the scope of the present invention.

### BRIEF DESCRIPTION OF THE DRAWINGS

The present invention may be better understood in conjunction with the following Figures:

FIG. 1 schematically illustrates a software application to be executed on an execution platform.

FIG. 2 schematically illustrates the software product 3 to be added to the software application 1 of FIG. 1.

FIG. 3 is a flow chart of a method for obtaining a protected application protected against unauthorized use by implementing a predetermined licensing model according to a preferred embodiment of the invention.

FIG. 4 schematically illustrates the protected software application executed on the execution platform according to a preferred embodiment.

FIG. 5 schematically illustrates the protected application executed on the execution platform according to a preferred embodiment of the invention.

FIG. 6 is a flow chart of a method for obtaining a protected application according to a preferred embodiment of the invention.

FIG. 7 is a flow chart of the method for obtaining a protected application according to another preferred embodiment.

FIG. 8 schematically illustrates the protected application executed on the execution platform according to another preferred embodiment of the invention.

FIG. 9 is a flow chart of the method for obtaining a protected application according to a preferred embodiment.

FIG. 10 schematically illustrates a computer for carrying out the method according to the preferred embodiments.

### DETAILED DESCRIPTION OF PREFERRED EMBODIMENTS

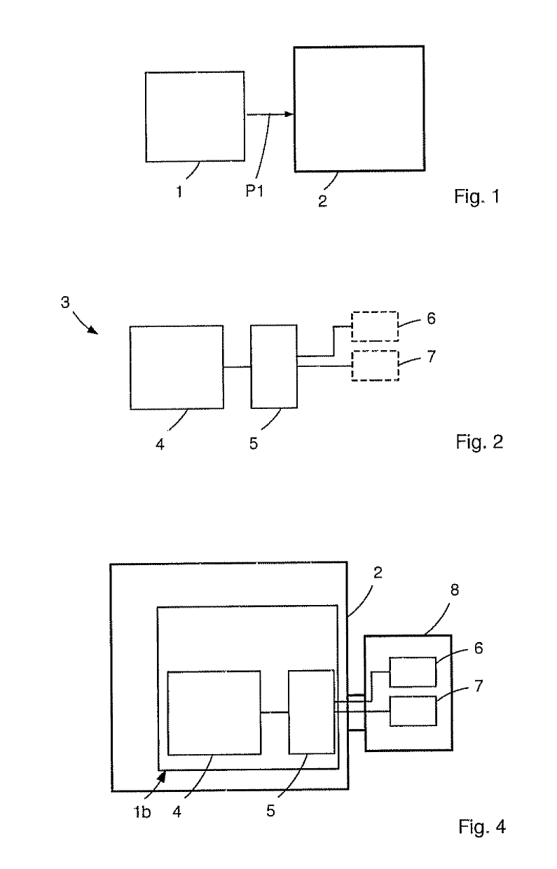

FIG. 1 schematically illustrates a software application 1 to be executed on an execution platform 2 (as indicated by the arrow P1).

In order to protect the software application 1 against unauthorized use by implementing a predetermined licensing model (e.g. a perpetual license) the software publisher or vendor of the software application 1 will protect the software application 1 to obtain a protected software application 1b and will deliver only the protected software application 1b to the end user executing the protected software application 1b on the execution platform 2 which can be for example a common personal computer.

According to a preferred embodiment the software publisher or vendor uses the software product 3 shown in FIG. 2 to obtain the protected application 1b. The software product 3 comprises a basic module 4 and a routing module 5. Further, the software product 3 provides two different functionalities 6 and 7 when the protected application 1b is installed and/or executed. Each of the functionalities 6, 7 can be realized in at least two different manners and need not to be already implemented in the software product 3 to be used for protecting the application 1. It is possible to realize the functionalities 6 and 7 in a special secure hardware device to be connected to the execution platform 2 or in a protected region of the execution platform 2, for example.

In this embodiment the functionalities 6 and 7 are not implemented in the software product 3 or are implemented only in part in the software product 3 so that the functionalities are indicated with dotted lines in FIG. 2.

The functionalities 6 and 7 are needed by the software product 3 to protect the software application 1 and therefore are needed by the protected application 1b. In this embodiment the first functionality 6 provides the possibility of using a secure memory which is protected against hacking. The second functionality 7 provides a cryptographic method for encrypting/decrypting of data to be exchanged between the software application 1 to be protected and the software product 3. The routing module 5 is used for logically connecting the realized functionalities 6 and 7 to the basic module 4.

Further, the software product 3 provides the possibility of defining one of the at least two different manners of realizing each functionality 6 and 7 and as a result, as described in detail in the following description, is possible to split up the process of protecting a software application 1 into a first part, which can be named pre-protection part, and a second part, which can be named selecting part.

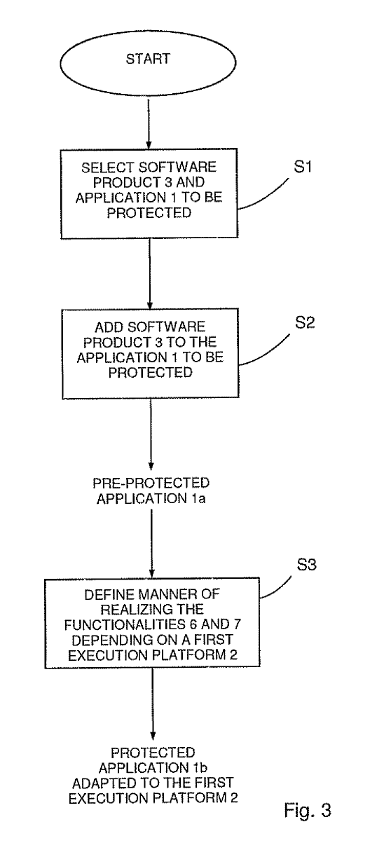

As shown in FIG. 3, in the pre-protection part of the method for obtaining a protected application the software publisher or vendor selects an application 1 to be protected and the software product 3 for protecting to the software application 1 (step S1).

In step S2 the software product 3 is added to the application 1 to be protected so that the pre-protected software application 1a is obtained. As a pre-protected application 1a an application is understood to which at least a part of the software product 3 is added.

In the selecting part of the method for obtaining a protected application the manner of realizing the first and second functionalities 6 and 7 is defined by configuring the routing module 5 and, if necessary, by adding code and/or data to the pre-protected application 1a (cf. step S3). Here, this is done depending on a first execution platform 2 on which the protected application 1b is to be executed. In this way a protected application 1b adapted to the first execution platform 2 is obtained and can be delivered to the end user by the software publisher or vendor.

In this embodiment it is defined that the functionalities 6 and 7 are to be realized in a secure hardware device 8 (which is also delivered to the end user) when the protected software application 1b is installed and/or executed on the first execution platform 2. The end user connects the secure hardware device 8 (cf. FIG. 4) to the execution platform 2 and executes the protected application 1b on the execution platform 2.

The secure hardware device 8 can be a hardware-based encryption engine which is used for encrypting and decrypting data for software protection. During the runtime of the protected application 1b the secure hardware device 8 receives encrypted strings from the protected application 1b and decrypts them in a way that can not be imitated. The decrypted data returned from the secure hardware device 8 is employed in the protected application 1b so that it affects the mode in which the protected software application 1b is executed: it may load and run, it may execute only certain components of the protected application 1b, or it may not execute the protected application 1b at all. The on-chip encryption engine of the secure hardware device 8 employs a 128-bit AES Encryption Algorithm.

Since the functionalities 6 and 7 are realized in the secure hardware device 8 the software application 1 is protected against unauthorized use.

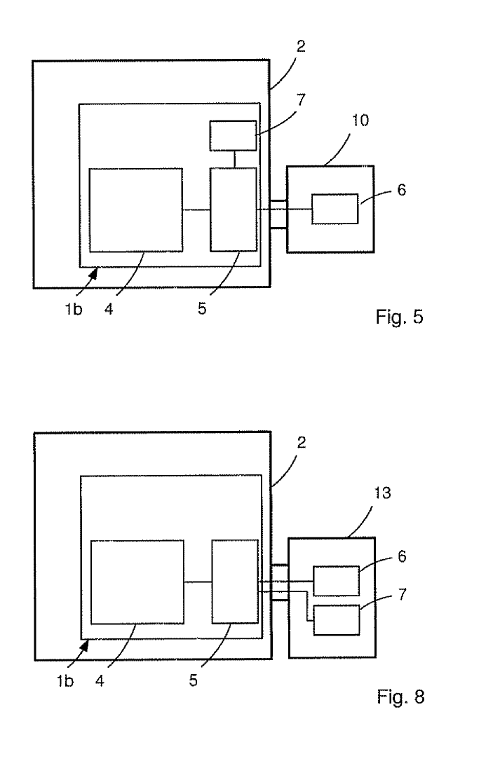

In FIG. 4 as well as in FIGS. 5 and 8 it is shown that at least the basic module 4 and the router module 5 are included in the protected application 1b. However, any other kind of adding the software product 3 to the application 1 to be protected can be realized.

If the software publisher or the vendor wishes to lock the protected software application 1b not with respect to the secure hardware device 8 as described above but to a commonly known SD card (secure digital card) 10 the software publisher or the vendor can carry out steps S1 and S2 in the same manner as described above. Only step S3 (in which it is defined how to realize the functionalities 6 and 7) has to be amended such that it is defined to realize the functionality 6 in the SD card 10 and to realize the functionality 7 in the protected application 1b itself. In order to use an SD card 10 the execution platform 2 (FIG. 5) normally includes a corresponding card reader (not shown in FIG. 5). In this example the SD card 10 can also be delivered to the end user by the vendor or software publisher.

It is further possible to use the unique identifier of the SD card 10 for protecting the application such that the unique identifier of the SD card 10 is used for deciding whether or not the SD card 10 is present. Only if the SD card 10 is present the protected application 1b is allowed to be executed. If the SD card is in possession of the software publisher or vendor the vendor or software publisher can use the unique identifier to protect the software application 1.

It is also possible that the end user transmits an unique identifier of his own SD card 10 to the software publisher or vendor and the software publisher or vendor can use this information in order to protect the software application in step S3. In this way the protected software application is locked to the SD card 10.

As described above the method for obtaining the protected application 1b protected against unauthorized use includes the pre-protection part (steps S1 and S2), in which the protection as such is added to the application 1, and the selecting part (step S3), in which it is defined to which device the protected application 1b is locked.

The device to which the application is locked can be a separate secure hardware device (for example the device 8 of FIG. 1 or the SD card 10 of FIG. 5), which is to be connected to the execution platform 2, as explained in connection with FIGS. 4 and 5. However, it is also possible to lock the protected application 1b with respect to the execution platform 2 itself. In particular, in this case, the execution platform 2 comprises a protected environment.

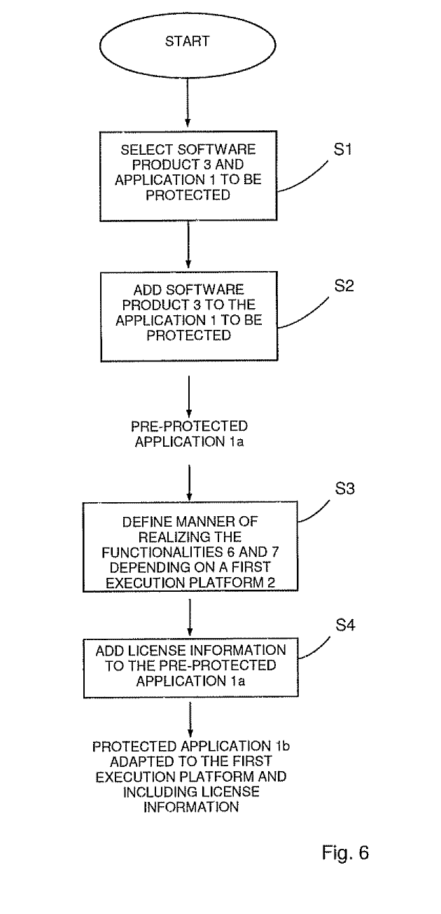

In another preferred embodiment the selecting part of the method is slightly amended compared with the method described in connection with FIG. 3. However, steps S1 to S3 are the same steps as in FIG. 3 and therefore reference is made to the corresponding description above. After the step S3 there is carried out a further step S4 (FIG. 6), in which the vendor or software publisher adds license information to the protected application. The added license information can be stored as a digitally signed information, for example.

Of course it is possible to carry out step S4 before carrying out step S3. It is also possible to combine the steps S3 and S4 to one single step.

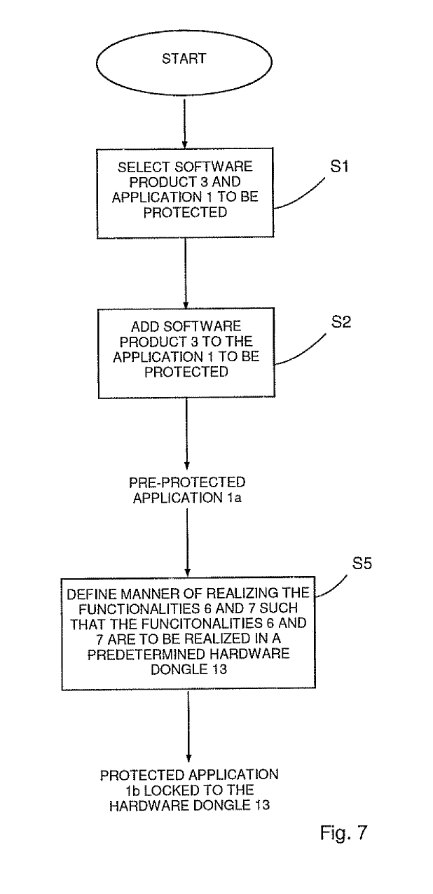

In a further preferred embodiment of the method of obtaining a protected application the same steps S1 and S2 are carried out as described in connection with FIG. 3. After step S2, however, a step S5 (cf FIG. 7) is carried out, in which it is defined that the functionalities 5 and 6 are to be realized in a predetermined hardware dangle 13, as indicated in FIG. 8.

For example, the predetermined hardware dangle 13 can be manufactured and sold by another company than the company manufacturing and selling the software product 3. Therefore, it is possible to provide a very flexible method for obtaining a protected application.

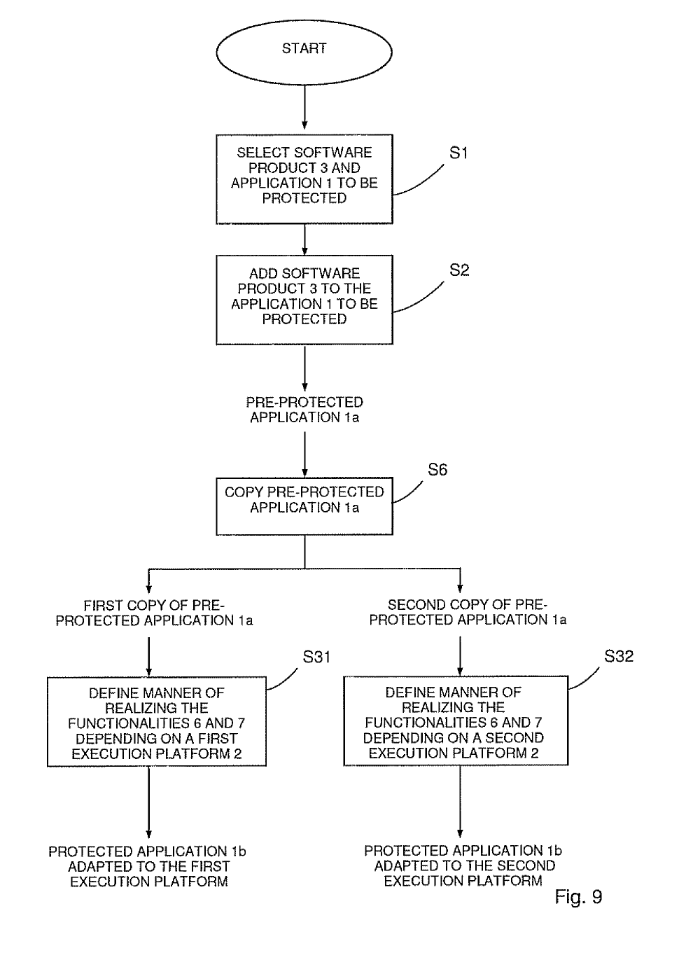

FIG. 9 shows a flow chart of a further preferred embodiment. The steps S1 and S2 are the same steps as described in connection with FIG. 3. However, the selecting part of the method is amended such that the protected application resulting from step S2 is copied twice. Then, the manner of realizing the functionalities is defined for each copy of the protected application depending on the corresponding execution platform on which the protected application is to be executed (steps S31, S32). Therefore, the vendor or software publisher only needs to carry out the protection part once for the application to be protected and can then carry out the selecting part individually for each copy of the protected application.

It is of course possible to generate more than two copies of the protected application in step S6.

The above described preferred embodiments of the method for obtaining a protected application (and in particular the steps thereof can be combined in any suitable manner.

In the embodiments described above the software product 3 provides a limited number of several different manners of realizing the functionalities 6 and 7, namely using a secure hardware device 8 or 10 or locking the protected application 1b to the execution platform 2. Therefore, when adding the software product 4 to the application 1 to be protected the maximum number of different manners of realizing the functionalities 6, 7 is set.

In a further embodiment it is possible to amend the software product 3 added to the software application 1 such that at least one additional different manner of realizing the functionalities 6, 7 is provided. Therefore, even protected applications in the field (for example used by an end user) can be amended to provide at least one additional different manner of realizing the functionalities 6, 7.

For example, the use of a new secure hardware device which is developed after the distribution of the protected software can be added for implementing the respective licensing model. In order to make this possible, the routing module 5 accepts added different manners of realizing the functionalities 6 and 7 only if a necessary signed digital certificate is also presented. The software product 3 can be designed such that only the company distributing the software product is allowed to add an additional manner. Further, it is of course possible, to design the software product such that also the vendor or software distributor of the protected software is allowed to add an additional manner.

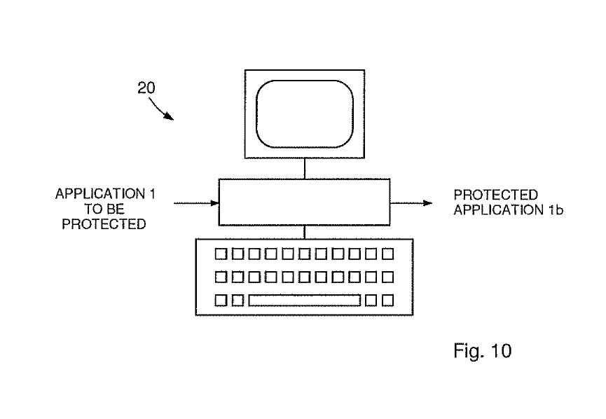

The methods of the preferred embodiments as described above can be carried out on a single computer 20 as schematically shown in FIG. 10, for example.

Those skilled in the art will appreciate that the invention can be embodied in other forms and ways, without departing from the scope of the invention. The embodiments described herein should be considered as illustrative and not restrictive

What is claimed is:

1. A method for obtaining a protected application protected against unauthorized use by implementing a predetermined licensing model, said method comprising the steps of:
adding a software product to said application, said software product providing the possibility of defining one of several different manners of realizing a functionality to be used for implementing the predetermined licensing model, and
defining one of the several manners of realizing the functionality.

2. The method of claim 1, wherein the defining step is carried out after the adding step.

3. The method of claim 1, wherein the functionality is at least one of the group comprising:
the possibility of using a secure memory,
a unique identifier,
a cryptographic method for decrypting data,
a cryptographic method for encrypting data,
secure execution of code for the protected application,
a cryptographic authentication, and
a license manager.

4. The method of claim 1, wherein in the defining step at least one of executable code and data for realizing the defined manner is added to the application to be protected.

5. The method of claim 1, wherein by adding the software product to said application a pre-protected application is obtained and wherein the pre-protected application is copied at least twice and in each copy of the pre-protected application a different manner of realizing the functionality is defined.

6. The method of claim 1, wherein the manner of realizing the functionality is defined such that the functionality is realized in a secure hardware device to be connected to an execution platform on which the protected application is executed.

7. The method of claim 1, wherein the defining step is carried out such that the defined manner is realized when installing or executing the protected application.

8. The method of claim 1, wherein the manner of realizing the functionality is defined such that the functionality is realized in an execution platform on which the protected application is executed.

9. The method of claim 1, wherein said software product comprises a basic module and a router module, said router module is used for logically connecting the realized functionality to the basic module.

10. The method of claim 1, wherein, after adding the software product to said application an extension step is carried out, in which at least one manner of realizing the functionality is added to said software product.

11. The method of claim 1, wherein, after adding the software product to said application an extension step is carried out, in which in the software product at least one of the different manners of realizing the functionality is replaced by another manner of realizing the functionality.

12. An apparatus for obtaining a protected application protected against unauthorized use by implementing a predetermined licensing model,
which apparatus
adds a software product to said application, said software product providing the possibility of defining one of several different manners of realizing a functionality to be used for implementing the predetermined licensing model, and defines one of the several manners of realizing the functionality.

13. The apparatus of claim 12, wherein the manner of realizing the functionality is defined after the step of adding the software product to the application.

14. The apparatus of claim 12, wherein in the defining step at least one of executable code and data for realizing the defined manner is added to the application to be protected.

15. The apparatus of claim 12, wherein by adding the software product to said application a pre-protected application is obtained and wherein the pre-protected application is copied at least twice and in each copy of the pre-protected application a different manner of realizing the functionality is defined.

16. A software product, which is to be added to an application in order to obtain a protected application protected against unauthorized use by implementing a predetermined licensing model,
said software product providing the possibility of defining one of several different manners of realizing a functionality to be used for implementing the predetermined licensing model.

17. The software product of claim 16, wherein the software product is designed such that the manner of realizing the functionality can be defined after adding the software product to the application.

18. The software product of claim 16, wherein one of the several manners of realizing the functionality is defined as default manner.

19. The software product of claim 16, wherein the functionality is at least one of the group comprising:
the possibility of using a secure memory,
a unique identifier,
a cryptographic method for decrypting data,
a cryptographic method for encrypting data,
secure execution of code for the protected application,
a cryptographic authentication, and
a license manager.

20. The software product of claim 16, wherein when defining the manner of realizing the functionality at least one of executable code and data is added to the application to be protected.

21. The software product of claim 16, wherein said software product is designed such that by adding the software product to said application a pre-protected application is obtained and wherein the pre-protected application is copied at least twice and in each copy of the pre-protected application the manner of realizing the functionality can be defined independently from each other.

22. The software product of claim 16, wherein said software product comprises a basic module and a router module, said router module is used for logically connecting the realized functionality to the basic module.

23. A method of distributing a software application, said method comprising the steps of:
protecting the software application to be distributed by adding a software product to said software application, said software product providing the possibility of defining one of several different manners of realizing a functionality to be used for implementing a predetermined licensing model, and defining one of the several manners of realizing the functionality,
sending the protected software application to the user.

24. The method of claims 23, wherein
the protected software application is electronically sent to the user, wherein the predetermined licensing model allows the use of the protected application on an execution platform for a limited time period and after expiration of the time period the execution is only allowed when a secure hardware device is connected to the execution platform,
and wherein the secure hardware device is sent to the user within the limited time period.

25. The method of claim 23, wherein
the predetermined licensing model only allows the execution of the protected software application on an execution platform when a secure hardware device is connected to the execution platform.

26. The method of claim 25, wherein
said software product is from a first company offering software protection systems and said secure hardware device is from a second company offering software protection systems.

27. The method of claim 23, wherein
by adding the software product to the software application a pre-protected software application is obtained and wherein the pre-protected software application is copied at least twice and in each copy of the pre-protected software application a different manner of realizing the functionality is defined.

28. The method of claim 23, wherein
the step of defining one of the several manners of realizing the functionality is carried out depending on the hacking activities expected in the market to which the user of the protected software application belongs.
